(19) United States
(12) Patent Application Publication
(10) Pub. No.: US 2021/0371314 A1
(43) Pub. Date: Dec. 2, 2021

(54) SYSTEMS AND METHODS FOR HULL WASTEWATER REMEDIATION

(71) Applicant: Sinku Water Services Corp., Halfmoon Bay (CA)

(72) Inventor: John Billings, Halfmoon Bay (CA)

(21) Appl. No.: 17/050,105

(22) PCT Filed: Apr. 23, 2019
(86) PCT No.: PCT/CA2019/050496

§ 371 Date: Oct. 23, 2020

Related U.S. Application Data
(60) Provisional application No. 62/661,371, filed on Apr. 23, 2018.

(51) Int. Cl. C02F 9/00

(52) U.S. Cl. CPC C02F 9/00; C02F 1/004

(57) ABSTRACT

Systems and methods for remediating hull wastewater are described herein. The systems include: a separation unit for separating a hull wastewater feed stream into a separated feed stream and a first solid waste stream, a filtration unit coupled to the separation unit for filtering the separated feed stream into a filtered stream and a second solids waste stream; a membrane filtration unit coupled to the filtration unit for membrane filtering the filtered stream into a membrane filtered stream and a third solids waste stream; an inactivation unit coupled to the membrane filtration unit for inactivating the membrane filtered stream into a final product stream; and a waste removal unit coupled to the separation unit and the filtration unit for receiving and dewatering the first solids waste stream and the second solids waste stream into a recycle stream and a waste product stream.

### CROSS-REFERENCE TO RELATED APPLICATION

This application claims the benefit of United States Provisional Patent Application 62/661,371 filed Apr. 23, 2018, herein incorporated by reference.

### TECHNICAL FIELD

The embodiments disclosed herein relate to systems and methods for water remediation, and, in particular to systems and methods for hull wastewater remediation.

### INTRODUCTION

Accumulation of algae and invertebrates (such as mussels, barnacles, and the like) can cause significant expense for commercial shipping operators. Marine growth on underside surfaces of ships can result in greater wear and tear, significant increase in fuel consumption and substantial maintenance costs. Accumulation of algae and invertebrates on underside surfaces of ships can also lead to the transportation of invasive plants and animal species from their native regions to other areas where they can create environmental damage and disruption.

To address marine growth on the underside of commercial ship, anti-fouling paints that inhibit marine growth have been developed. Unfortunately, these paints tend to be damaging to the environment as they contain heavy metals and are sometimes considered pesticides. Many jurisdictions have banned or are considering implementing bans on the use of anti-fouling paints and even on entry of ships having anti-fouling paints into the country's waterways. Despite this, anti-fouling paints and other similar protective coatings continue to be used.

For larger ships, mechanical scrubbing techniques utilizing brush cleaning machines or the like are commonly used to remove marine growth while the ship is in the water. For smaller vessels such as recreational boats, the cleaning procedures are typically performed by divers using hand-held tools including hand-held scrubbing pads and brushes. For larger scale cleaning operations on commercial vessels, sophisticated hydraulic cleaning equipment and heavy duty scrubbers may be operated from one or more specially-fitted workboats in conjunction with trained divers, or remote controlled self-propelled vehicles may be used. Regardless of the scrubbing mechanism, the scrubbing action can release particulates into the water, with the risk of dissemination of invasive flora or fauna, or chemicals, including heavy metals from anti-fouling paints, which can harm local marine life and impact water quality. Some areas may prohibit or restrict the use of such equipment due to the environmental effects on the marine life in areas where the mechanical cleaning occurs.

Marine growth and wastewater extracted from the undersides of ships must be treated to allow biologically inactive and heavy metal reduced seawater to be returned to the harbor where the ship sits to prevent environmentally harmful contaminants such as invasive species and heavy metals from the surface of the paints, from being released to the harbor, while selectively collecting all solids for land-based removal. Cleaning and/or remediating the hull wastewater has proven to be challenging. For instance, many attempts to remove all viable invasive organisms found to be resident within the hull-attached detritus have been unsuccessful due to an inability to eliminate biological particles down to the sub-micron size range. These systems generally rely on filters that eliminate particles down to a range of about 5 to 50 microns, which still provides for passage of viable propagules back into the marine environment. Many bacteria fall outside of the effective lower limit of simple filtration technology.

Accordingly, there is a need for new or improved systems and methods for hull wastewater remediation.

### SUMMARY

According to some embodiments, a system for remediating hull wastewater is described herein. The system includes a separation unit for separating a hull wastewater feed stream into a separated feed stream and a first solid waste stream, the hull wastewater feed stream comprising heavy metal and microbial solid particulate material; a filtration unit coupled to the separation unit for filtering the separated feed stream into a filtered stream and a second solids waste stream; a membrane filtration unit coupled to the filtration unit for membrane filtering the filtered stream into a membrane filtered stream and a backwash waste stream; an inactivation unit coupled to the membrane filtration unit for inactivating output from the membrane filtered stream into a final product stream, the final product stream to be returned to seawater; and a waste removal unit coupled to the separation unit and the filtration units for receiving and dewatering the first solids waste stream and the second solids waste stream into a recycle stream and a waste product stream.

According to some embodiments, the filtration unit comprises two screen filters, a first screen filter for filtering the separated feed stream into the filtered stream and the second solid waste stream, and a second screen filter for filtering the third solids stream into a second filtered stream and a fourth solids waste stream.

According to some embodiments, the recycle stream is directed to the second screen of the filtration unit to combine with the third solids waste stream for separation into the second filtered stream and the fourth solids waste stream.

According to some embodiments, the waste removal unit receives the fourth solids waste stream.

According to some embodiments, the first solids waste stream comprises solid particulate matter greater than 500 microns.

According to some embodiments, the second solids waste stream comprises solid particulate matter greater than 50 microns.

According to some embodiments, the third solids waste stream comprises solid particulate matter greater than 25 microns.

According to some embodiments, the membrane filtration unit includes an ultrafiltration unit that filters particulate matter from the feed stream down to 0.02 microns.

According to some embodiments, the inactivation unit includes a UV unit for inactivating viable biological components in the membrane filtered stream and an activated media unit for removing heavy metals from the membrane filtered stream.

According to some embodiments, the product stream is substantially free of invasive species.

According to some embodiments, the product stream is substantially free of heavy metals including copper.

According to some embodiments, following the separation unit, the system is a continuous system.

According to some embodiments, the system is a closed system.

According to some embodiments, a method of remediating hull wastewater is described herein. The method includes separating a hull wastewater feed stream into a separated feed stream and a first solid waste stream in a separation unit, the hull wastewater feed stream comprising heavy metal and microbial solid particulate material; filtering the separated feed stream into a filtered stream and a second solids waste stream in a filtration unit; membrane filtering the filtered stream into a membrane filtered stream and a third solid waste stream in a membrane filtration unit; inactivating the membrane filtered stream into a final product stream in an inactivation unit, the final product stream to be returned to seawater; and dewatering the first solids waste stream and the second solids waste stream in a dewatering unit.

It should be noted that throughout the description, the term “separation stage” is optionally referred to as a “separator” or a “separation unit”. Likewise, the term “filtration stage” is optionally referred to as a “filter” or a “filtration unit”, “membrane filtration stage” is optionally referred to as a “membrane filter” or a “membrane filtration unit”, “inactivation stage” is optionally referred to as an “inactivator” or an “inactivation unit” and the “waste removal stage” is optionally referred to as a “waste remover” or a “waste removal unit”.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic view of a system for remediating hull wastewater, according to one embodiment; and

FIG. 2 is a block diagram of a method for remediating hull wastewater, according to one embodiment.

### DETAILED DESCRIPTION

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the result is not significantly changed. These terms of degree should be construed as including a deviation of the modified term, such as 1%, 2%, 5%, or 10%, for example, if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

In spite of the technologies that have been developed for cleaning the undersides of boats and remediating wastewater therefrom, there remains a need for improvements in the development of systems and methods for hull wastewater remediation. In accordance with the teachings herein, various embodiments are described for systems and methods for remediating hull wastewater (i.e. seawater mixed with materials removed from the undersides of a hull of a ship, the undersides including but not limited to the portions of the hull below the surface of the water) using a closed system. Remediating hull wastewater includes but is not limited to removing materials including contaminants (e.g. heavy metals) and other microbial solid particulate material (e.g. from soft slime and algal components up to solid materials as found in mussels and barnacle shells, starfish, crinoids and the like, bacteria, some viruses, and the like.) from the hull wastewater to return it to seawater. For instance, in each of the embodiments described herein, the systems and methods inhibit release of contaminants from the hull cleaning system.

In some embodiments described here, once hull wastewater is received by the system, there is little to no opportunity for loss of material (including contaminates and microbial solid particulate material) from the system to enter the environment outside of the system. Each stage of the systems described herein generally occurs in a unit or units that confine all liquids within their footprint. The final product stream from the system (that is generally fit to be returned to the seawater and/or harbor environment adjacent to the ship) may be free of invasive species (i.e. a plant, fungus, or animal species that is not native to a specific location (an introduced species), and that has a tendency to spread to a degree believed to cause damage to the environment, human economy or human health) and may have a heavy metal concentration at or below jurisdictional Water Quality Guidelines (which may vary by jurisdiction).

As described previously, the undersides of many ships may be painted with ablative biocidal paints of various types. The most common type of paint used includes elemental copper, and copper ions can be slowly released into solution and act as a generic biocide for most organisms that might otherwise attach to hulls of ships. In some embodiments of the systems and methods described herein, heavy metals such as but not limited to copper, nickel, zinc, cobalt, cadmium and the like, may be selectively removed after being detached from the hull during cleaning. For example, the systems and methods described herein may remove other solid particulate and dissolved forms of the most common heavy metals used in the marine industry (e.g. copper and zinc) as well as other heavy metals. At the same time, the systems and methods described herein may be flexible enough to be able to turn off and/or eliminate heavy metal removal components, for example, to more efficiently deal with detritus (other microbial solid particulate material (e.g. from soft slime and algal components up to solid materials as found in mussels and barnacle shells, starfish, crinoids and the like, bacteria, some viruses, and the like.) from vessels that do not have an ablative biocidal hull paint covering. The terms “detritus”, “biological solid materials”, “microbial solid particulate materials” and the like are used interchangeably herein and refer to biological matter typically found as fouling on the hull of ships.

Further still, the systems and methods described herein utilize a series of processes that sequentially remove solids having smaller particle sizes from a hull wastewater stream to provide a final product stream having solids with a size in a range of about 0.01 to about 0.1 microns. Achieving this level of solids removal may provide for removal of the majority of viable microorganisms such as but not limited to algae, macro-fouling, bacteria and even some viruses. Further, the residual solids in the product stream are generally in a size range that can be efficiently inactivated by the application of UV irradiation. Herein, in some embodiments, the term “inactivating” includes disinfecting or killing biological materials.

For example, the systems and methods described herein may use compartmentalization of processes whereby fouling from the hull of the ship is removed in a step-by-step manner, largest first, then in a cascading series with a reduction in size class at each successive stage. This serial reduction in size prevents blockage of the following stage. This unique interdependency is critical to the successful removal of invasive species.

It should be noted that the systems and methods described herein are intended to be mobile systems that can be transported to various ports for use adjacent to the ship being cleaned. The systems and methods described herein may be used in different operational environments such as but not limited to dockside, barge-mounted or vessel-mounted. For instance, the systems and methods described herein may be operational within the confines of a standard 20 foot metal sea container. This may provide for mobility from ship-to-ship in a dock environment, while also being available to mount on a barge or on the deck of a tender vessel.

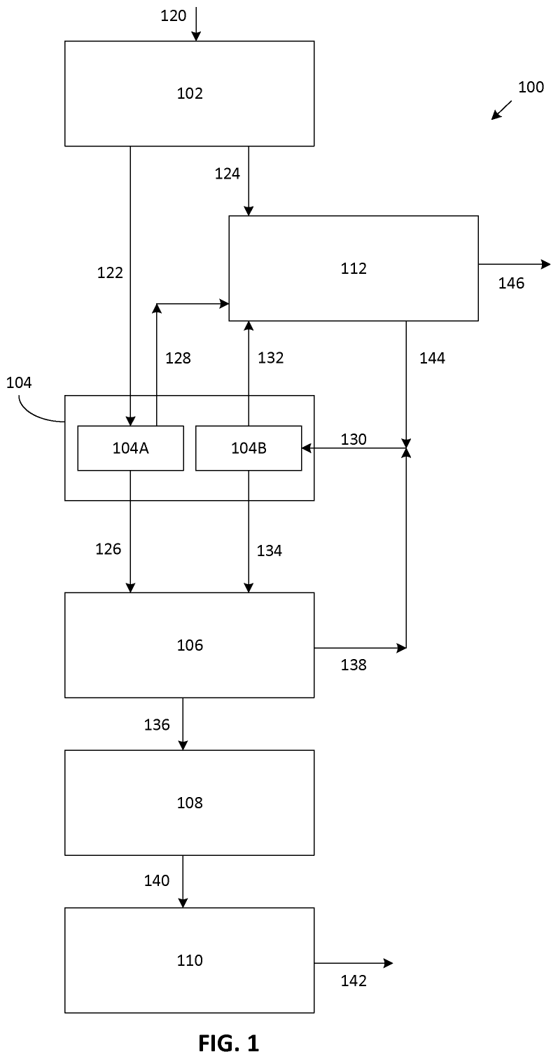

Referring to FIG. 1, illustrated therein is a system 100 for remediating hull wastewater. The system 100 includes a separation stage 102, a filtration stage 104, a membrane filtration stage 106, an inactivation stage 108, a media filtering stage 110 and a waste removal stage 112.

Ships may present with a wide variety of fouling on their hulls, dependent upon their travel history, how long they may have been at anchor, the water temperatures they have encountered, etc. System 100 is capable of separating various types of fouling (i.e. detritus or detritus material). System 100 may accept and separate a wide variety of biological materials and contaminants (e.g. heavy metals) that may be found attached to a hull of a ship. Generally, the fouling removed from the hull of the ship is in any type of mixture that may be delivered to the input of the system.

Separation stage 102 separates a hull wastewater feed stream 120 into a product stream 122 and a first waste stream 124 using a filter. The hull wastewater feed stream 120 may be provided to the separation stage 102 from a ship's hull by way of a removal system (e.g. including a removal tool such as but not limited to a hand tool and a pump; not shown).

Separation stage 102 separates the hull wastewater feed stream 120 into two separate streams: a product stream 122 including seawater mixed with solid particulate material and first waste stream 124.

In some embodiments, the product stream 122 includes solid particulate material under about 1000 microns, or under about 900 microns, or under about 800 microns, or under about 700 microns, or under about 600 microns, or under about 500 microns. In some embodiments, the first waste stream 124 includes substantially all solid particulate material from the hull wastewater feed stream 120 over about 1000 microns, or over about 900 microns, or over about 800 microns, or over about 700 microns, or over about 600 microns, or over about 500 microns.

In some embodiments, separation stage 102 may include an inclined cylinder with a rotating auger for separating detritus material (e.g. solids) in the hull wastewater feed stream 120. The detritus material separated from the hull wastewater stream 120 may include marine life in whole, crushed or fragmented form. Generally, prior to being provided to the separation stage 102, fouling is removed from the hull of the ship and mixed with ambient seawater by the removal system (not shown) and provided to the separation stage 102 at a designated pressure and flow rate.

In some embodiments, separation stage 102 includes a stainless-steel inclined cylinder, housing a stainless-steel mesh screen with a pore size of about 500 microns and a stainless-steel auger turned by an electric motor. The cylinder, screen and auger may be inclined to provide for solids waste to be carried up the auger and out an outlet at the top of the auger. Hull wastewater feed stream 120 can be fed at a lower end of the auger. The auger turning inside the screen may provide for the seawater and solids waste having a particle size less than about 500 microns to flow out a product port of the separation stage 102, while solids waste having a particle size approximately greater than 500 microns is moved out a waste port by the auger.

In some embodiments, the flow rate of the hull wastewater feed stream may be in a range of about 50 to about 600 gallons per minute (GPM). In other embodiments, the flow rate of the hull wastewater feed stream may be in a range of about 400 to about 500 GPM. It should be noted that hull cleaning heads (of the removal system) generally range in size, and therefore the systems and methods described herein should be able to accommodate a wide range of flow rates of hull wastewater into the system 100. For instance, large removal systems may produce a hull wastewater input stream 120 with a flow rate in a range of about 400 to 600 GPM, whereas smaller heads and hand tool-based removal systems used to clean niche areas and strongly curved surfaces may only produce a hull wastewater flow rate in a range of about 60 to 100 GPM.

To accommodate for this potential high variability of hull wastewater flow rates, the system 100 may include a control system (not shown) that can monitor flow rates throughout the system, electronically couple to control valves within the system to adjust and/or control flow rates (e.g. by limiting or augmenting flow) to and from various stages and/or units in the system to provide for flow rates within an acceptable range for each stage and/or unit.

For example, in some embodiments, a valve can be placed in the hull wastewater feed stream 120 to control the flow rate of the hull wastewater feed stream 120 into system 100. In some embodiments, the valve may be a polyvinyl chloride (PVC) 80 valve.

For example, the product stream 122 can have a flow rate in a range of about 100 to about 600 gallons per minute. One or more valves (not shown) may be positioned in the product stream 122 to control the flow rate of the product stream 122 from the separation stage 102 to the filtration stage 104. This valve may be a PVC (polyvinyl chloride) 80 valve.

In some embodiments, a booster pump (not shown) can be positioned in the product stream 122 between the separation stage 102 and the filtration stage 104. As noted earlier, the flow rate and/or pressure of the hull wastewater feed stream 120 is variable and depends on the tool used for collecting the feed stream 120, a distance between the tool and the system 100, etc. The booster pump may provide for control of the flow rate and pressure of product stream 122 into the filtration stage 104. In some embodiments, the booster pump may increase the pressure of the product stream to about 70 psi (or about 480 kPa).

Filtration stage 104 separates product stream 122 into a filtered stream 126 and a second waste stream 128. Filtration stage 104 is fluidly coupled to membrane filtration stage 106.

In some embodiments, filtration stage 104 includes a screen filter for separating the product stream 122 into a filtered stream 126 and a second waste stream 128. In other embodiments, filtration stage 104 includes at least two screen filters for separating the product stream 122 into a filtered stream 126 and a second waste stream 128. For instance, the at least two screen filters can be operated in series and have successively declining pore sizes to successively remove solids of declining sizes.

In some embodiments, a first screen filter having a pore size in a range of about 25 microns to about 100 microns can be followed by a second screen filter, in series, having a pore size of about 25 microns to about 50 microns to produce filtered stream 126 having solids particulate with a size that is in a range of about 25 microns to about 50 microns.

In some embodiments, a stainless steel screen having a pore size in a range of about 25 microns to about 150 microns can be followed by a stainless steel screen having a pore size in a range of about 25 microns to about 50 microns to produce filtered stream 126 having solids particulate with a size that is in a range of about 25 microns to about 50 microns.

In one embodiment, a stainless steel screen having a pore size of about 50 microns can be followed by a stainless steel screen having a pore size of about 25 microns to produce filtered stream 126 having solids particulate with a size that is or is less than about 25 microns.

In some embodiments, the filtration stage 104 includes two filtration stages, a first filtration stage 104A and a second filtration stage 104B. First filtration stage 104A and second filtration stage 104B can be operated in tandem and can each include two or more screens having successively declining pore sizes to successively remove solids of declining sizes. As shown in FIG. 1, first filtration stage 104A may separate the product stream 122 into filtered stream 126 and second waste stream 128 and second filtration stage 104B may separate a recycle stream 130 into a third waste stream 132 and a second filtered stream 134. Generally, the filtered stream 126 and the second filtered stream 134 each have solids particulate with a size of about 25 microns or less.

Recycle stream 130 may include a backwash product stream from a subsequent unit (described further below).

In some embodiments, filtration stage 104 can be configured to automatically backwash the screens therein to provide for second waste stream 128 and/or third waste stream 132. For instance, in one embodiment, when the internal inlet to outlet differential pressure across first filtration stage 104A and/or second filtration stage 104B reaches a pressure in a range of about 5 to 7 PSI, the control system (not shown) can trigger the filtration stage to initiate cleaning of the screen by, for example, brushing the screen-trapped material from screens of stage 104. This seawater-suspended particulate generates second waste stream 128 and third waste stream 132, respectively, and can be removed from the stage through a waste port. It should be noted that this backflow cleaning cycle may not interrupt the flow of product stream 122 or the operation of filtration stage 104. The flow rate of second waste stream 128 and third waste stream 132 are each generally less than 1% of total feed flow of hull wastewater stream 120 into the system 100. The flow rate of product stream 122 into the filtration stage 104 may be in a range from about 150 GPM to about 540 GPM.

In some embodiments, separation in second filtration stage 104B occurs through a fine mesh (e.g. stainless steel mesh) screen that provides for liquid and particulates up to five microns in size to flow through. Larger particles are trapped and held until backwash is triggered. The fine mesh screen may be within a cylindrical chamber where the flow enters at a first end of the cylindrical chamber and exits at a second, opposed end.

The second and third waste streams 128 and 132, respectively, join the first waste stream 124 at waste stage 112.

At membrane filtration stage 106, the first and second filtered streams 126, 134, respectively, are separated by an ultrafiltration membrane filter into a membrane filtered stream 136 and a backwash (e.g. fourth) waste stream 138. Membrane filtration stage 106 generally filters solids particulate matter larger than about 0.10 microns, or larger than about 0.09 microns, or larger than about 0.08 microns, or larger than about 0.07 microns, or larger than about 0.06 microns, or larger than about 0.05 microns, or larger than about 0.04 microns, or larger than about 0.03 microns, larger than about 0.02 microns, or larger than about 0.01 microns from the first filtered stream 126 and the second filtered stream 134. The backwash waste stream 138 from the ultrafiltration membrane filter may be routed back to filtration stage 104, specifically to second filtration stage 104B.

In some embodiments of membrane filtration stage 106, the pressure of the first filtered stream 126 and the second filtered stream 134 may be adjusted to about 40 PSI and distributed evenly to a series of filter membranes. Each membrane may have many filter fibres that provide for seawater liquid in the first filtered stream 126 and the second filtered stream 134 to flow through while all solids greater than about 0.10 microns, or greater than about 0.09 microns, or greater than about 0.08 microns, or greater than about 0.07 microns, or greater than about 0.06 microns, or greater than about 0.05 microns, or greater than about 0.04 microns, or greater than about 0.03 microns, or greater than about 0.02 microns, or greater than about 0.01 microns may be trapped in the membrane. Each fibre within each membrane may collect solid material having a particle size greater than the aforementioned sizes, including but not limited to bacteria and some viruses, and hold them awaiting backwash. At a predetermined pressure differential, backwash of the membranes can be initiated and all of the fibres of the membranes can be are cleaned. The membrane is then available to be returned to production. The backwash product forms backwash (e.g. fourth) waste stream 138 which may be carried by a backwash pump to one or the filtrating stage 104 (as shown in FIG. 1) or the waste stage 112.

In some embodiments, the series of filter membranes include four trains of four membranes each. The number of trains online at any one time may provide for flexible flow rates within the system 100 and may be adjusted/controlled by the control system. Generally, the flow rate of inputs (e.g. streams 126 and 134) to the membrane filtration stage 106 is in a range of about 100 to 600 GPM. Further, having multiple trains of multiple filter membranes can provide for membrane filtration stage 106 being adaptable to a wide range of flow rates and can provide for backwash of each of the membrane filters of membrane filtration stage 106 without interruption. Further, all trains can be monitored for pressure and flow. Backwash timing and product quality may be controlled by the control system. Each train of membranes may also include sample ports for quality control.

One example of ultrafiltration membranes that can be used in the membrane filtration stage 106 are dizzer® ultrafiltration membranes by Inge (Germany).

At waste stage 112, the first waste stream 124 and the second waste stream 128, and optionally the third waste stream 132, are collected from separation stage 102 and the filtration stage 104 for dewatering. First waste stream 124 and second waste stream 128 generally form a heavy waste sludge that may be dewatered to divide off water from the solid materials.

In some embodiments, waste stage 112 includes a press for dewatering to divide off water from the waste streams and produce a dry cake that can be transported to recycling for landfill, for example. In some embodiments, the press uses hydraulic pressure to compress the solid waste and force liquid (e.g. water) through a filter layer and out a liquid product port. The water produced by the press is removed from waste stage 112 as recycle stream 144 and fed back into second filtration stage 104B. Recycle stream 144 may include a one-way motorized check valve controlled by the control system utilizing flow and pressure differential. Recycle stream 144 can be re-directed to the filtration stage 104 as described below.

In other embodiments, other dewatering units can be used to divide off water from the waste streams and produce a dry cake that can be transported to recycling for landfill, for example.

It is of significant economic consideration that the costs of disposal of the solid components (e.g. solids waste stream 146) be managed to the lowest level possible. Accordingly, in some embodiments, waste stage 112 may achieve about 80% removal of the water content of the input waste streams 124, 128, 132 to achieve a dry solids waste stream 146.

At inactivation stage 108, membrane filtered stream 136 having solids particulate in a range of about 0.01 microns to about 0.10 microns, or about 0.02 microns or less, can be directed to at least one ultraviolet (UV) filter to inactivate remaining microbes and/or biological material in the membrane filtered stream 136. In some embodiments, inactivation stage 108 may include one UV filter to inactivate remaining microbes and/or biological material in the membrane filtered stream 136. In other embodiments, inactivation stage 108 may include two or more UV filters operating in series to inactivate remaining microbes and/or biological material in the membrane filtered stream 136. In some embodiments, the flow rate of membrane filtered stream 136 may impact whether or not one or more than one UV filter is included at inactivation stage 108.

In one embodiment, membrane filtered stream 136 may enter inactivation stage 108 through a side port of a stainless-steel cylinder and be forced through a series of baffle plates and around a series of UV reactors disposed therein. Inactivation of residual sub-micron sized biological contaminants—such as but not limited to bacteria and viruses—can be achieved. Pressure and flow rates can be monitored by the control system, as well as reactor intensity, to ensure proper operation. After biological inactivation, inactivated stream 140 is directed to a media bed filtering stage 110.

At media filtering stage 110, inactivated stream 140 may be routed to an activated column, for example, to remove any residual heavy metals (e.g. copper) in inactivated stream 140 to produce a final product stream 142. In some embodiments, the activated column is an activated charcoal column.

In one embodiment of media filtering stage 110, media filtering stage 110 receives inactivated stream 140 from inactivation stage 108 at a feed port and flows into a pipe carrying the inactivated stream 140 down the center of a fibreglass tank to a distribution array where it is diffused through a bed of activated media (e.g. activated carbon). After adsorption of heavy metals, etc. to the activated media (e.g. activated carbon), the fluid exits through a product port of the tank. The tank may include a sample port on the product port to provide for testing for the presence of invasive species and heavy metals prior to the final product stream 142 being returned to the seawater.

In some embodiments, an absolute 0.2-micron filter may be positioned between inactivation stage 108 and media filtering stage 110 to remove any media fines that may be transported in inactivated stream 140.

It should be noted that the inactivation stage 108 and the media filtering stage 110 can be considered to be a single inactivation stage where the membrane filtered stream 136 is both inactivated and filtered using activated media in a single stage.

Further, it should also be noted that the order of inactivation stage 108 and media filtering stage 110 can be reversed, where membrane filtered stream 110 is directed to media filtering stage 110 for filtering and a product stream from media filtering stage 110 is directed to inactivation stage 108. In this arrangement, inactivation stage 108 produces the final product stream 142. Further still, in some embodiments, inactivation stage 108 and the media filtering stage 110 can be optional stages and the membrane filtered stream may be appropriate for being redirected to the seawater.

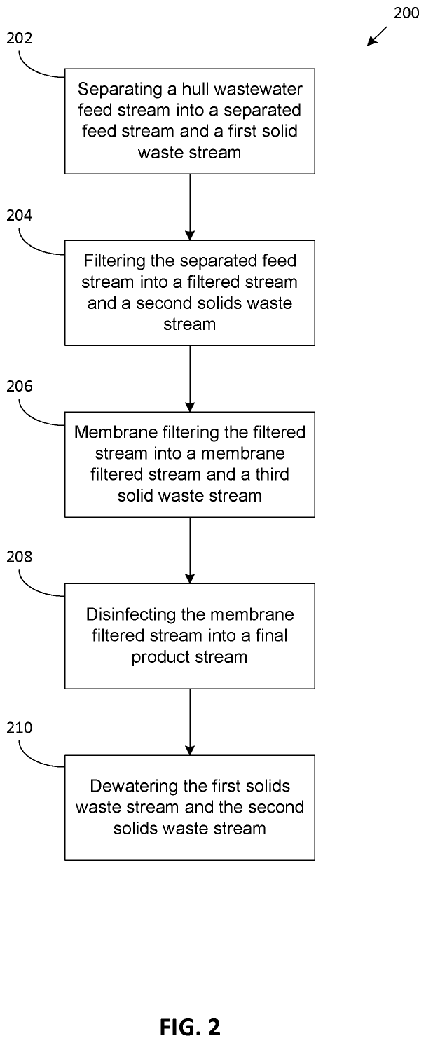

Referring now to FIG. 2, illustrated therein is a method 200 of remediating hull wastewater.

In some embodiments, the method 200 includes a first step 202, separating a hull wastewater feed stream into a separated feed stream and a first solid waste stream in a separation unit, the hull wastewater feed stream comprising heavy metal and microbial solid particulate material.

In some embodiments, the method 200 includes a second step 204, filtering the separated feed stream into a filtered stream and a second solids waste stream in a filtration unit.

In some embodiments, the method 200 includes a third step 206, membrane filtering the filtered stream into a membrane filtered stream and a third solid waste stream in a membrane filtration unit.

In some embodiments, the method 200 includes a fourth step 208, inactivating the membrane filtered stream into a final product stream in an inactivation unit.

In some embodiments, the method 200 includes a fifth step 210, dewatering the first solids waste stream and the second solids waste stream in a dewatering unit.

While the above description provides examples of one or more apparatus, methods, or systems, it will be appreciated that other apparatus, methods, or systems may be within the scope of the claims as interpreted by one of skill in the art.

1. A system for remediating hull wastewater comprising:
a) a separation unit for separating a hull wastewater feed stream into a separated feed stream and a first solid waste stream, the hull wastewater feed stream comprising heavy metal and microbial solid particulate material;
b) a filtration unit coupled to the separation unit for filtering the separated feed stream into a filtered stream and a second solids waste stream;
c) a membrane filtration unit coupled to the filtration unit for membrane filtering the filtered stream into a membrane filtered stream and a third solids waste stream;
d) an inactivation unit coupled to the membrane filtration unit for inactivating the membrane filtered stream into a final product stream, the final product stream to be returned to seawater; and
e) a waste removal unit coupled to the separation unit and the filtration unit for receiving and dewatering the first solids waste stream and the second solids waste stream into a recycle stream and a waste product stream.

2. The system of claim 1, wherein the filtration unit comprises two screen filters, a first screen filter for filtering the separated feed stream into the filtered stream and the second solid waste stream, and a second screen filter for filtering the third solids stream into a second filtered stream and a fourth solids waste stream.

3. The system of claim 2, wherein the recycle stream is directed to the second screen of the filtration unit to combine with the third solids waste stream for separation into the second filtered stream and the fourth solids waste stream.

4. The system of claim 3, wherein the waste removal unit receives the fourth solids waste stream.

5. The system of claim 1, wherein the first solids waste stream comprises solid particulate matter greater than about 500 microns.

6. The system of claim 1, wherein the second solids waste stream comprises solid particulate matter greater than about 50 microns.

7. The system of claim 1, wherein the third solids waste stream comprises solid particulate matter greater than about 25 microns.

8. The system of claim 1, wherein the membrane filtration unit includes an ultrafiltration unit that filters particulate matter from the feed stream down to about 0.02 microns.

9. The system of claim 1, wherein the inactivation unit includes a UV irradiation unit for inactivating viable biological materials in the membrane filtered stream and an activated media unit for removing heavy metals from the membrane filtered stream.

10. The system of claim 1, wherein the product stream is substantially free of invasive species.

11. The system of claim 1, wherein the product stream is substantially free of heavy metals, optionally copper, nickel, zinc, cobalt and cadmium.

12. The system of claim 1, wherein following the separation unit, the system is a continuous system.

13. The system of claim 1, wherein the system is a closed system.

14. A method of remediating hull wastewater, the method comprising:
a) separating a hull wastewater feed stream into a separated feed stream and a first solid waste stream in a separation unit, the hull wastewater feed stream comprising heavy metal and microbial solid particulate material;
b) filtering the separated feed stream into a filtered stream and a second solids waste stream in a filtration unit;
c) membrane filtering the filtered stream into a membrane filtered stream and a third solid waste stream in a membrane filtration unit;
d) inactivating the membrane filtered stream into a final product stream in an inactivation unit, the final product stream to be returned to seawater; and
e) dewatering the first solids waste stream and the second solids waste stream in a dewatering unit.

15. The method of claim 14, wherein the filtration unit comprises two screen filters, a first screen filter for filtering the separated feed stream into the filtered stream and the second solid waste stream, and a second screen filter for filtering the third solids stream into a second filtered stream and a fourth solids waste stream.

16. The method of claim 15, further comprising directing the recycle stream to the second screen of the filtration unit to combine with the third solids waste stream for separation into the second filtered stream and the fourth solids waste stream.

17. The method of claim 16, wherein the waste removal unit receives the fourth solids waste stream.

18. The method of claim 14, wherein the first solids waste stream comprises solid particulate matter greater than about 500 microns.

19. The method of claim 14, wherein the second solids waste stream comprises solid particulate matter greater than about 50 microns.

20. The method of claim 14, wherein the third solids waste stream comprises solid particulate matter greater than about 25 microns.

21. The method of claim 14, wherein the membrane filtration unit includes an ultrafiltration unit that filters particulate matter from the feed stream down to about 0.02 microns.

22. The method of claim 14, wherein the inactivation unit includes a UV inactivation unit for treating the membrane filtered stream and an activated media unit for removing heavy metals from the membrane filtered stream.

23. The method of claim 14, wherein the product stream is substantially free of invasive species.

24. The method of claim 14, wherein the product stream is substantially free of heavy metals including copper.
